(19) United States
(12) Patent Application Publication
(10) Pub. No.: US 2012/0207483 A1
(43) Pub. Date: Aug. 16, 2012

(54) Apparatus and Method for Control the Driving Amplitude of Differential Quadrature Phase Shift Keying Transmitter

(75) Inventors: Ping Cui, Shenzhen (CN); Xiaoyu Zhu, Shenzhen (CN)

(73) Assignee: ZTE CORPORATION, Shenzhen City, Guangdong Province (CN)

(21) Appl. No.: 13/501,595

(22) PCT Filed: Jun. 25, 2010
(86) PCT No.: PCT/CN10/74513

§ 371 Date: Apr. 12, 2012

(30) Foreign Application Priority Data
Oct. 16, 2009 (CN) 200910178323.9

(51) Int. Cl. H04B 10/04

(52) U.S. Cl. 398/188

(57) ABSTRACT

The present invention discloses an apparatus and a method for controlling a driving amplitude of a DQPSK transmitter. The method includes: a DQPSK modulator modulating an optical signal emitted from a CW and without adding with modulated signal; a modulator feedback control unit is connected with a first bias point, a second bias point and a third bias point and controls the first bias point, the second bias point and the third bias point according to a part of the optical signal modulated by the DQPSK modulator; controlling the driving amplitude of a driver I according to temperature change of the driver I; controlling the driving amplitude of a driver Q according to temperature change of the driver Q. The present invention can be used to simplify complexity of the control circuit of the DQPSK transmitter, and therefore no extra optical signal-to-noise ratio cost would be created.

### TECHNICAL FIELD

The present invention relates to the communications equipment, and more particularly, to an apparatus and a method for controlling driving amplitude of a differential quadrature phase shift keying transmitter.

### BACKGROUND OF THE RELATED ART

A lot of new modulation techniques, such as DPSK (Differential Phase Shift Keying), DQPSK (Differential Quadrature Phase Shift Keying), and so on, are applied in the optical communication, and the DQPSK coding occupies an important position in the 40G optical communication system because it can reduce the requirements on rate, dispersion and PMD (polarization mode dispersion) of electrical devices. When a DQPSK transmitter modulates to generate a NRZ-DQPSK (Non-Return-to-Zero-DQPSK) signal by using an MZM (Mach-Zender Modulator), the effect due to the change of the driving amplitude is much bigger than the NRZ-DPSK.

FIG. 1 is a schematic diagram of influence of modulating driving amplitude, wherein, FIG. 1A is a schematic diagram of an OSNR (Optical Signal Noise Ratio) tolerance curve. In FIG. 1A, ———— denotes the OSNR tolerance curve when the optical filter bandwidth is 37.5 GHz (bit error rate (BER)=1e-4); — • — • denotes the OSNR tolerance curve when the optical filter bandwidth is 75 GHz (BER=1e-4); and ---------- denotes the OSNR tolerance curve when the optical filter bandwidth is 75 GHz (BER=1e-12). FIG. 1B is a schematic diagram of a dispersion tolerance curve in simulation, and in FIG. 1B, ———— denotes the dispersion tolerance curve when the optical filter bandwidth is 37.5 GHz (BER=1e-4); — • — • denotes the dispersion tolerance curve when the optical filter bandwidth is 75 GHz (BER=1e-4); and ---------- denotes the dispersion tolerance curve when the optical filter bandwidth is 75 GHz (BER=1e-12). In different optical filter bandwidths (37.5 GHz and 75 GHz), the curves of the OSNR tolerance and the back to back 2 dB OSNR cost dispersion tolerance following the change of modulating the driving amplitude are shown in FIG. 1.

It can be seen from FIG. 1 that, when the driving amplitude is less than 1.1 Vpi, in the two optical filter bandwidths (37.5 GHz and 75 GHz), with the decreasing of the driving amplitude, both the OSNR tolerance and the 2 dB OSNR cost dispersion tolerance increase rapidly, and when the driving amplitude is reduced to 0.5 Vpi, compared with the 1.1 Vpi, it brings that the OSNR cost is more than 4 dB, which is much larger than the case of NRZ-DPSK. When the driving amplitude is larger than 1.1 Vpi, in the two optical filter bandwidths (37.5 GHz and 75 GHz), with the increasing of the driving amplitude, the OSNR tolerance and the 2 dB OSNR cost dispersion tolerance remain stable at first, and then increase rapidly, but the increasing rate is slower than that at the decreasing of the driving amplitude; and when the driving amplitude increases to 1.5 Vpi, compared with the 1.1 Vpi, it brings that the OSNR cost is almost 2 dB, which is much larger than the case of NRZ-DPSK.

The change of the driving amplitude has relatively large influence on the NRZ-DQPSK performance, and when the driving amplitude is 1.1 Vpi, although the dispersion tolerance is minimum, its OSNR performance is the best. For the NRZ-DQPSK system with rate of 40 Gb/s, a superior OSNR performance is more concerned, thus the best driving amplitude is taken as 1.1 Vpi. Therefore, the stability of the driving amplitude has a large influence on the OSNR performance of the NRZ-DQPSK transmitter, and the driving amplitude needs to be controlled strictly.

FIG. 2 is a block diagram of a structure of a feedback control apparatus of a DQPSK transmitter. In FIG. 2, the CW denotes the continuous spectrum light source of the unmodulated signal, the driver I and the driver Q denote drivers of two upper and lower Mach-Zender modulators of the DQPSK modulator, the Bias 1, Bias 2 and Bias 3 are the bias point 1, the bias point 2 and the bias point 3. As shown in FIG. 2, the light emitted from the CW is modulated by the DQPSK modulator to generate a modulated optical signal to output, wherein, a part of the modulated optical signal is used to control the states of the modulator, the driver I and the driver Q.

The disadvantage of the related art is that: since the DQPSK transmitter needs to control the three bias points of the modulator, the control circuit is relatively complicated already, then, if the driving amplitude is controlled by using the conventional method in which the pilot signal is added and by the time division multiplexing mode, the control circuit is very large, and adding the pilot signal might introduce a certain amount of OSNR cost.

### CONTENT OF THE INVENTION

The technical problem to be solved in the present invention is to provide an apparatus and a method for controlling driving amplitude of a differential quadrature phase shift keying transmitter, so as to simplify the complexity of the control circuit of the DQPSK transmitter.

The present invention provides an apparatus for controlling driving amplitude of a DQPSK transmitter, and the apparatus comprises: a first bias point, a second bias point, a third bias point, a driver I, a driver Q, and a DQPSK modulator for modulating an optical signal emitted by the CW, the apparatus also comprises:

a modulator feedback control unit, which is connected with the first bias point, the second bias point and the third bias point, and is configured to control the first bias point, the second bias point and the third bias point according to a part of the optical signal modulated by the DQPSK modulator;

a driver I feedback control unit, which is connected with the driver I and is configured to control the driving amplitude of the driver I according to temperature change of the driver I; and

a driver Q feedback control unit, which is connected with the driver Q and is configured to control the driving amplitude of the driver Q according to temperature change of the driver Q.

Preferably, the driver I feedback control unit comprises:

a first temperature sensor, which is connected with the driver I and is configured to detect the temperature change of the driver I; and

a first direct compensation module, which is configured to compensate in light of a temperature compensation curve and according to the temperature change of the driver I, and after obtaining an offset of a drain voltage of a third-level metal oxide semiconductor field effect transistor (MOSFET) of the driver I, feed back the offset to a switching power supply converter connected with the driver I, so as to control change of the drain voltage of the third-level MOSFET of the driver I.

Preferably, the driver Q feedback control unit comprises:

a second temperature sensor, which is connected with the driver Q and is configured to detect the temperature change of the driver Q; and

a second direct compensation module, which is configured to compensate in light of a temperature compensation curve and according to the temperature change of the driver Q, and after obtaining an offset of a drain voltage of a third-level MOSFET of the driver Q, feed back the offset to a switching power supply converter connected with the driver Q, so as to control change of the drain voltage of the third-level MOSFET of the driver Q.

Preferably, the temperature compensation curve is obtained according to the driving amplitude of an output signal of the driver and the drain voltage of the MOSFET of the driver.

Preferably, the driver I feedback control unit comprises:

a first current monitoring module, which is connected with a drain voltage of a third-level MOSFET of the driver I and is configured to monitor current change of the drain voltage of the third-level MOSFET of the driver I; and

a first indirect compensation module, which is configured to control voltage change of a gate voltage of the third-level MOSFET according to the current change of the drain voltage of the third-level MOSFET of the driver I, and control the current change of the drain voltage of the third-level MOSFET by controlling the voltage change of the gate voltage of the third-level MOSFET.

Preferably the driver Q feedback control unit comprises:

a second current monitoring module, which is connected with a drain voltage of a third-level MOSFET of the driver Q and is configured to monitor current change of the drain voltage of the third-level MOSFET of the driver Q; and

a second indirect compensation module, which is configured to control voltage change of a gate voltage of the third-level MOSFET according to the current change of the drain voltage of the third-level MOSFET of the driver Q, and control the current change of the drain voltage of the third-level MOSFET by controlling the voltage change of the gate voltage of the third-level MOSFET.

The present invention provides a method for controlling driving amplitude of a DQPSK transmitter, and the method comprises:

modulating, by a DQPSK modulator, an optical signal emitted from a CW;

connecting a modulator feedback control unit with a first bias point, a second bias point and a third bias point, and controlling, by the modulator feedback control unit, the first bias point, the second bias point and the third bias point according to a part of the optical signal modulated by the DQPSK modulator;

controlling the driving amplitude of a driver I according to temperature change of the driver I;

controlling the driving amplitude of a driver Q according to temperature change of the driver Q.

Preferably, controlling the driving amplitude of the driver I according to the temperature change of the driver I comprises:

detecting the temperature change of the driver I;

compensating in light of a temperature compensation curve and according to the temperature change of the driver I, and after obtaining an offset of a drain voltage of a third-level metal oxide semiconductor field effect transistor (MOSFET) of the driver I, feeding back the offset to a switching power supply converter connected with the driver I, so as to control change of the drain voltage of the third-level MOSFET of the driver I;

and/or,

controlling the driving amplitude of the driver Q according to the temperature change of the driver Q comprises:

detecting the temperature change of the driver Q;

compensating in light of a temperature compensation curve and according to the temperature change of the driver Q, and after obtaining an offset of a drain voltage of a third-level MOSFET of the driver Q, feeding back the offset to a switching power supply converter connected with the driver Q, so as to control change of the drain voltage of the third-level MOSFET of the driver Q.

Preferably, the temperature compensation curve is obtained according to the driving amplitude of an output signal of the driver and the drain voltage of the MOSFET of the driver.

Preferably, controlling the driving amplitude of the driver I according to the temperature change of the driver I comprises:

monitoring current change of a drain voltage of a third-level MOSFET of the driver I;

controlling voltage change of a gate voltage of the third-level MOSFET according to the current change of the drain voltage of the third-level MOSFET of the driver I, and controlling the current change of the drain voltage of the third-level MOSFET by controlling the voltage change of the gate voltage of the third-level MOSFET;

and/or,

controlling the driving amplitude of the driver Q according to the temperature change of the driver Q comprises:

monitoring current change of a drain voltage of a third-level MOSFET of the driver Q;

controlling voltage change of a gate voltage of the third-level MOSFET according to the current change of the drain voltage of the third-level MOSFET of the driver Q, and controlling the current change of the drain voltage of the third-level MOSFET by controlling the voltage change of the gate voltage of the third-level MOSFET.

The beneficial effects of the present invention are as follows:

in the implementation of the present invention, since the modulator feedback control unit is connected with the first bias point, the second bias point and the third bias point, the first bias point, the second bias point and the third bias point are controlled according to a part of the optical signal modulated by the DQPSK modulator; however, the part of the modulated optical signal is not used to control the states of the driver I of the driver Q any more; meanwhile, the driving amplitudes of the driver I and the driver Q are controlled according to the temperature changes of the driver I and the driver Q, rather than controlled by the modulator feedback control unit, so that the driver amplitude control circuit is separated from the feedback control of the DQPSK modulator, and the driving amplitude of the driver is controlled through the temperature change of the driver. Therefore, compared with the related art, the present invention can simplify the complexity of the control circuit of the DQPSK transmitter. Moreover, there is no need to add the pilot signal on the driving amplitude of the driver, thus no extra OSNR cost is created.

### BRIEF DESCRIPTION OF DRAWINGS

FIG. 1 is a schematic diagram of influence of modulating driving amplitude in the related art, wherein: FIG. 1A is a schematic diagram of an OSNR tolerance curve, and FIG. 1B is a schematic diagram of a dispersion tolerance curve in simulation;

FIG. 2 is a block diagram of a structure of a feedback control apparatus of a DQPSK transmitter in the related art;

FIG. 3 is a structural diagram of an apparatus for controlling driving amplitude of a DQPSK transmitter in accordance with an embodiment of the present invention;

FIG. 4 is a schematic diagram of a driver feedback control in a direct compensation mode in accordance with an embodiment of the present invention;

FIG. 5 is a schematic diagram of a temperature compensation curve in a direct compensation mode in accordance with an embodiment of the present invention;

FIG. 6 is a schematic diagram of a driver feedback control in an indirect compensation mode in accordance with an embodiment of the present invention;

FIG. 7 is a flow chart of a method for controlling driving amplitude of a DQPSK transmitter in accordance with an embodiment of the present invention.

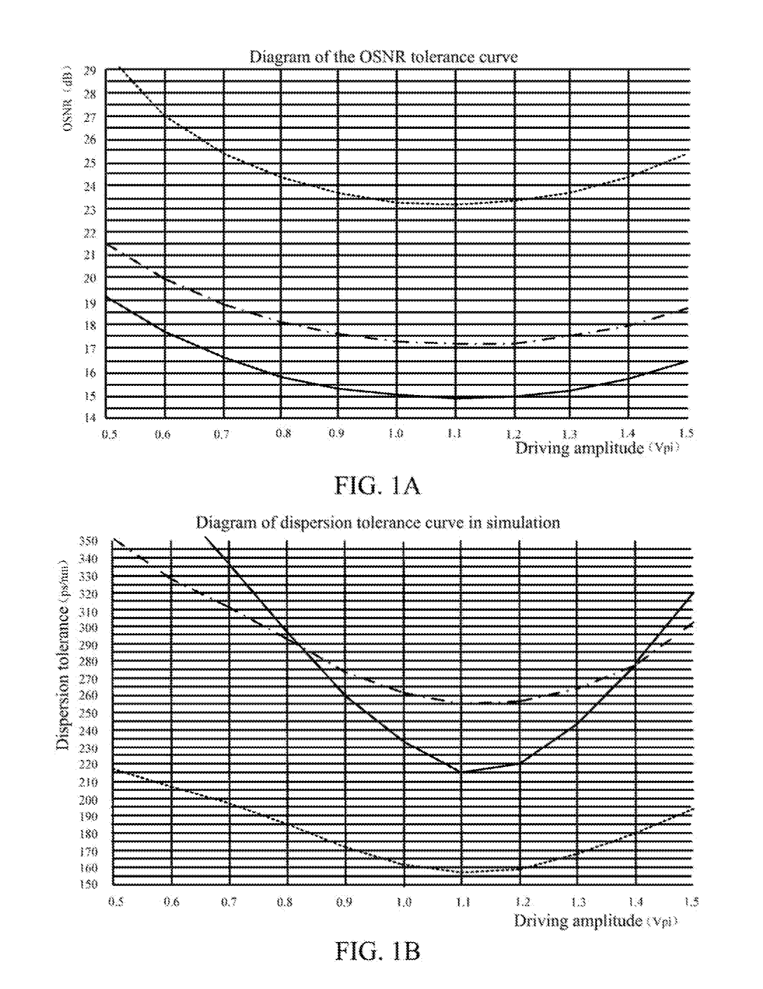

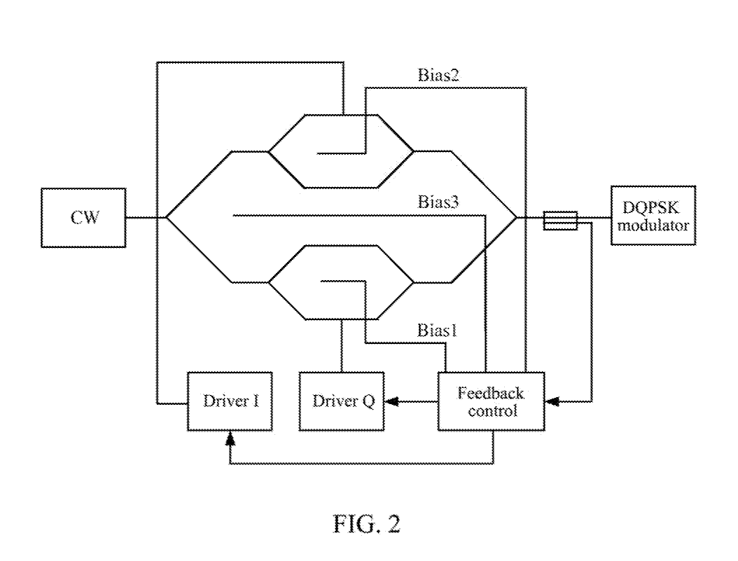

### PREFERRED EMBODIMENTS OF THE PRESENT INVENTION

Since a DQPSK transmitter needs to control three bias points of a modulator, the control circuit is relatively complicated already, then, if the driving amplitude is controlled by using the conventional method in which the pilot signal is added and by the time division multiplexing mode, the control circuit is very large, and at the same time adding the pilot signal might introduce a certain amount of OSNR cost. Therefore, embodiments of the present invention provide a new technique for monitoring and controlling the driving amplitude, to simplify multiple intercoupling control circuits of the DQPSK transmitter, and to get rid of the mode in which the original driving amplitude control needs to use the modulator to feed back, but some signals of the driver itself are only needed to act as the feedback signals to control the driving amplitude. In the following, the specific embodiments of the present invention will be illustrated in combination with the accompanying drawings.

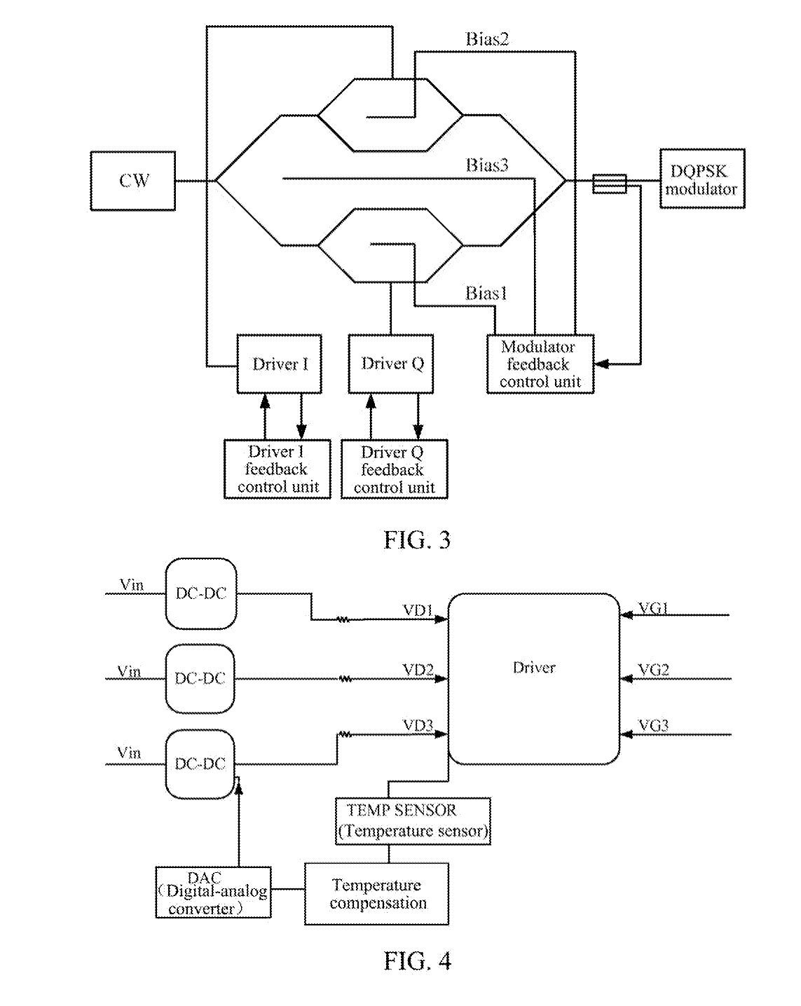

FIG. 3 is a structural diagram of an apparatus for controlling driving amplitude of a DQPSK transmitter. As shown in FIG. 3, the apparatus comprises: the first bias point Bias 1, the second bias point Bias2, the third bias point Bias3, the driver I, the driver Q, and the DQPSK modulator which modulates the optical signal emitted from the CW, and the apparatus also comprises:

a modulator feedback control unit, which is connected with the first bias point, the second bias point and the third bias point and is used to control the first bias point, the second bias point and the third bias point according to a part of the optical signal modulated by the DQPSK modulator; wherein, the part of the optical signal is about 10%;

the driver I feedback control unit, which is connected with the driver I and is used to control the driving amplitude of the driver I according to the temperature change of the driver I;

the driver Q feedback control unit, which is connected with the driver Q and is used to control the driving amplitude of the driver Q according to the temperature change of the driver Q.

From the aforementioned scheme, it can be seen that the modulator feedback control unit does not detach a part of the modulated optical signal to control the states of the driver I and the driver Q, the driver amplitude control circuit is separated from the feedback control of the DQPSK modulator, and other feedback signals are used to control the driving amplitude, that is: the driving amplitude of the driver is controlled according to the temperature change of the driver.

In the implementation, considering that the existing high-speed drivers of which the signal bandwidth is up to 30-40 GHz almost use a multi-polar FET (field effect transistor) amplifier serial structure, the amplifier gain will change with the change of the temperature, which will lead to the change of the driving amplitude. Therefore, different embodiments of controlling the driving amplitude by using the temperature are provided in the following.

### Embodiment One

FIG. 4 is a schematic diagram of a driver feedback control in a direct compensation mode. In FIG. 4, the driver has three levels, and each level is considered as a MOSFET (Metal Oxide Semiconductor Field Effect Transistor); VD3 is a drain voltage of the third-level MOSFET, VD2 is a drain voltage of the second-level MOSFET, and VD1 is a drain voltage of the first-level MOSFET.

The DC-DC is a switching power supply converter, Vin is an input voltage converted by the DC-DC power supply.

The TEMP SENSOR is a temperature sensor.

The VG is a gate voltage of the MOSFET.

The DAC is a Digital to Analog Converter.

As shown in FIG. 4, in the direct compensation mode, the driving amplitude of this driver is related to the VD3, thus the temperature sensor can be used to detect the temperature of the driver, and then a temperature compensation algorithm is used to change the feedback network of DC-DC, thus changing the value of the VD3, so as to ensure the driving amplitude of the driver unchanged. Specifically, the process is that: the temperature sensor firstly detects the temperature of the driver, and calculates an offset of the VD3 by using the temperature compensation algorithm, then the DAC feeds back the offset to the DC-DC, and then the DC-DC controls the output voltage so as to change the value of the VD3. The driver I and the driver Q can individually use the temperature control circuit to control the driving amplitude. The modulator feedback control unit can use any control mode which will not affect the driver control circuit.

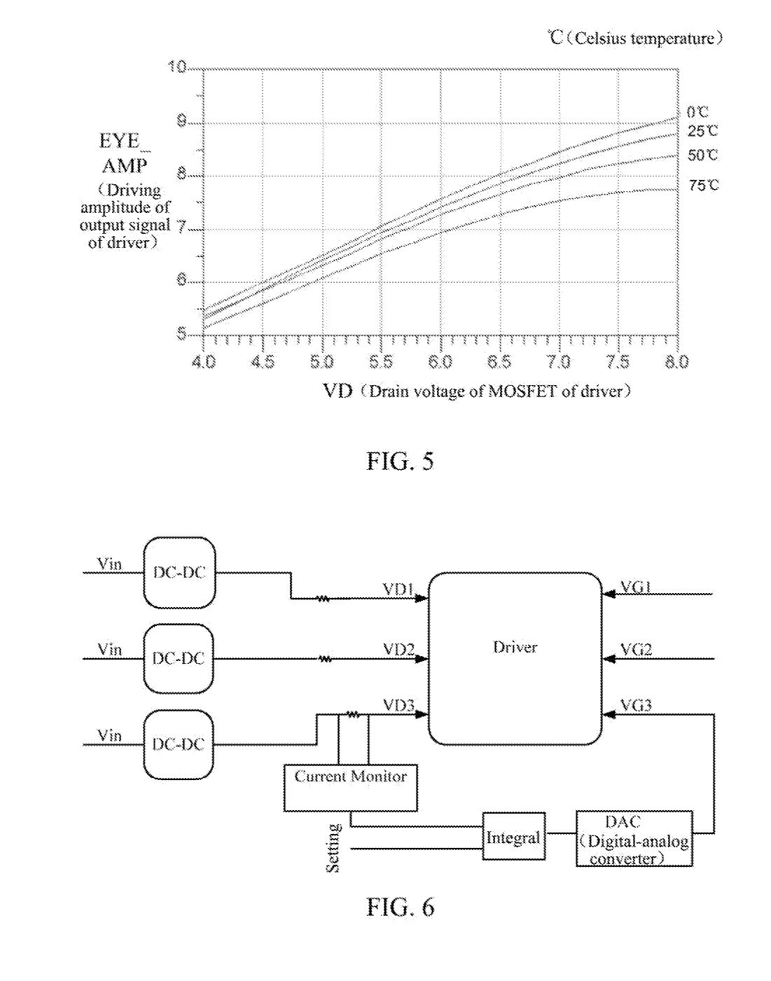

FIG. 5 is a schematic diagram of a temperature compensation curve in a direct compensation mode. In FIG. 5, EYE-AMP is the driving amplitude of the output signal of the driver, C is the Celsius temperature, and VD is the drain voltage of the MOSFET of the driver. As shown in FIG. 5, the temperature compensation curve can be used to change the feedback network of the DC-DC, that is, the temperature compensation curve can be obtained according to the driving amplitude of the output signal of the driver and the drain voltage of the MOSFET of the driver, so as to be used for temperature compensation.

From the aforementioned embodiment, it can be seen that in the specific implementation, the control for the driver I and/or the driver Q can be as follows.

The driver I feedback control unit can comprise:

a first temperature sensor, which is connected with the driver I and is used to detect the temperature change of the driver I;

a first direct compensation module, which is used to compensate in light of the temperature compensation curve and according to the temperature change of the driver I to obtain the offset of the VD3, and then feed back the offset of the VD3 to the switching power supply converter DC-DC, so as to control the change of the drain voltage VD3 of the third-level MOSFET.

The driver Q feedback control unit can comprise:

a second temperature sensor, which is connected with the driver Q and is used to detect the temperature change of the driver Q;

a second direct compensation module, which is used to compensate in light of the temperature compensation curve and according to the temperature change of the driver Q, and then feed back to the switching power supply converter DC-DC, so as to control the change of the drain voltage VD3 of the third-level MOSFET.

### Embodiment Two

FIG. 6 is a schematic diagram of a driver feedback control in an indirect compensation mode. In FIG. 6, the driver has three levels, wherein, the VD3 is the drain voltage of the third-level MOSFET, the VD2 is the drain voltage of the second-level MOSFET, and the VD1 is the drain voltage of the first-level MOSFET.

The DC-DC is a switching power supply converter, the Vin is the input voltage converted by the DC-DC power supply.

The Current Monitor is a current monitor.

The VG is the gate voltage of the MOSFET.

The DAC is a Digital to Analog Converter.

As shown in FIG. 6, in the indirect compensation mode, if the driving amplitude of the driver changes due to the influence of the temperature, then the current through the VD3 might change, so that whether the driving amplitude of the driver changes can be indirectly detected by monitoring the current of the VD3. If the current change is monitored, then the current of the VD3 can be corrected by changing the voltage of the VG3, to guarantee the current of the VD3 unchanged, thus the driving amplitude of the driver is controlled. The driver I and the driver Q can individually use the temperature control circuit to control the driving amplitude. The modulator feedback control unit can use any control mode which will not affect the driver control circuit.

From the aforementioned embodiment, in the specific implementation it can be seen that, the control for the driver I and/or the driver Q can be as follows.

The driver I feedback control unit can comprise:

a first current monitoring module, which is connected with the VD3 of the driver I and is used to monitor the current change of the VD3 of the driver I;

a first indirect compensation module, which is used to control the voltage change of the gate voltage VG3 of the third-level MOSFET according to the current change of the VD3 of the driver I, and control the current change of the drain voltage VD3 of the third-level MOSFET by controlling the voltage change of the VG3.

The driver Q feedback control unit can comprise:

a second current monitoring module, which is connected with the VD3 of the driver Q and is used to monitor the current change of the VD3 of the driver Q;

a second indirect compensation module, which is used to control the voltage change of the VG3 according to the current change of the VD3 of the driver Q, and control the current change of the drain voltage VD3 of the third-level MOSFET by controlling the voltage change of the VG3.

In the aforementioned embodiment, the control mode of the direct compensation mode is simple, and the feedback control can be executed as long as the whole temperature range of the compensation curve of the driver is known. The control mode of the indirect compensation mode is relatively complicated, and the feedback control is executed which is required to use the current monitoring mode. However, the control accuracy of the indirect compensation mode is higher than that of the direct compensation mode, and the driving amplitude can be controlled by monitoring the tiny change in current. In the specific implementation, different control modes can be applied according to different application scenarios.

The direct compensation and indirect compensation are taken for example to illustrate in the implementation, but in theory, other modes might be also used, as long as the driving amplitude of the driver can be controlled according to the temperature change of the driver; and the direct compensation and the indirect compensation are only used to teach those skilled in the art how to implement the present invention, which are not intended to user the two modes only, and in the implementation process, an appropriate mode might be determined in combination with the practical requirement.

Based on the same inventive concept, the embodiments of the present invention also provides a method for controlling the driving amplitude of the DQPSK transmitter. Since the principle of this method to solve the problem is similar to the apparatus for controlling the driving amplitude of the DQPSK transmitter, the implementation of this method can refer to the implementation of the apparatus and the repeated places are not repeated here.

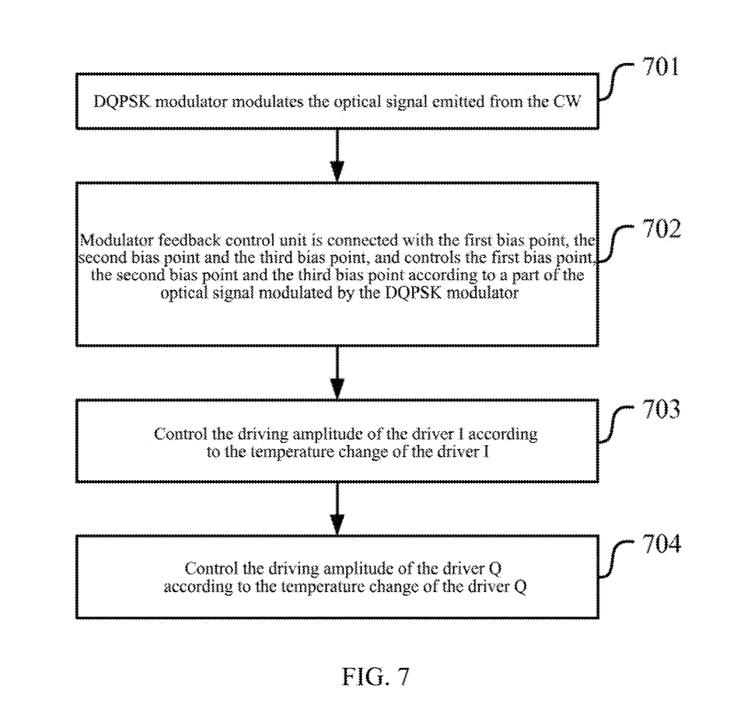

FIG. 7 is a diagram of an implementation process of a method for controlling driving amplitude of a DQPSK transmitter, and as shown in FIG. 7, the following steps can be comprised when controlling the driving amplitude:

in step 701, the DQPSK modulator modulates the optical signal emitted from the CW;

in step 702, the modulator feedback control unit is connected with the first bias point, the second bias point and the third bias point, and controls the first bias point, the second bias point and the third bias point according to a part of the optical signal modulated by the DQPSK modulator;

in step 703, the driving amplitude of the driver I is controlled according to the temperature change of the driver I;

in step 704, the driving amplitude of the driver Q is controlled according to the temperature change of the driver Q.

In the implementation, there is no necessary timing requirement among steps 702, 703, 704.

In the implementation, controlling the driving amplitude of the driver I according to the temperature change of the driver I can comprise:

detecting the temperature change of the driver I;

compensating in light of the temperature compensation curve and according to the temperature change of the driver I, and then feeding back to the switching power supply converter DC-DC, so as to control the change of the drain voltage VD3 of the third-level MOSFET.

In the implementation, controlling the driving amplitude of the driver Q according to the temperature change of the driver Q can comprise:

detecting the temperature change of the driver Q;

compensating in light of the temperature compensation curve and according to the temperature change of the driver Q, and then feeding back to the switching power supply converter DC-DC, so as to control the change of the drain voltage VD3 of the third-level MOSFET.

In the implementation, the temperature compensation curve can be obtained according to the driving amplitude of the output signal of the driver and the drain voltage of the MOSFET of the driver.

In the implementation, controlling the driving amplitude of the driver I according to the temperature change of the driver I can comprise:

monitoring the current change of the VD3 of the driver I;

controlling the voltage change of the gate voltage VG3 of the third-level MOSFET according to the current change of the VD3 of the driver I, and controlling the current change of the drain voltage VD3 of the third-level MOSFET by controlling the voltage change of the VG3.

In the implementation, controlling the driving amplitude of the driver Q according to the temperature change of the driver Q can comprise:

monitoring the current change of the VD3 of the driver Q;

controlling the voltage change of the VG3 according to the current change of the VD3 of the driver Q, and controlling the current change of the drain voltage VD3 of the third-level MOSFET by controlling the voltage change of the VG3.

From the aforementioned embodiment, it can be seen that, in the technical solution provided in the embodiments of the present invention, since the modulator feedback control unit is used to control the voltages of the three bias points of the DQPSK modulator, the driver feedback control unit is used to individually control the driving amplitude of the driver. Compared with the related art, the present invention can simplify the complexity of the control circuit of the DQPSK transmitter. Moreover, the present invention does not need to add the pilot signal on the driving amplitude of the driver, thus no extra OSNR cost would be created.

Although the preferred embodiments of the present invention are described, once those skilled in the art acquire the basic creative concept, they can make additional changes and modifications on these embodiments. Therefore, the appended claims intend to include the preferred embodiments as well as all changes and modifications that fall into the scope of the present invention.

Obviously, those skilled in the art can make various modifications and variations on the present invention, without departing from the spirit and scope of the present invention. Thus, if these modifications and variations of the present invention fall into the scope of the claims of the present invention and its equivalent technologies, then the present invention also intends to include these modifications and variations into.

What is claimed is:

1. An apparatus for controlling driving amplitude of a differential quadrature phase shift keying (DQPSK) transmitter, comprising: a first bias point, a second bias point, a third bias point, a driver I, a driver Q, and a DQPSK modulator for modulating an optical signal emitted by a continuous wave light source (CW) of an unmodulated signal, wherein, the apparatus further comprises: a modulator feedback control unit, a driver I feedback control unit and a driver Q feedback control unit; wherein,
the modulator feedback control unit is connected with the first bias point, the second bias point and the third bias point, and is configured to control the first bias point, the second bias point and the third bias point according to a part of the optical signal modulated by the DQPSK modulator;
the driver I feedback control unit is connected with the driver I and is configured to control the driving amplitude of the driver I according to temperature change of the driver I; and
the driver Q feedback control unit is connected with the driver Q and is configured to control the driving amplitude of the driver Q according to temperature change of the driver Q.

2. The apparatus of claim 1, wherein, the driver I feedback control unit comprises a first temperature sensor and a first direct compensation module; wherein,
the first temperature sensor is connected with the driver I and is configured to detect the temperature change of the driver I; and
the first direct compensation module is configured to compensate in light of a temperature compensation curve and according to the temperature change of the driver I, and after obtaining an offset of a drain voltage of a third-level metal oxide semiconductor field effect transistor (MOSFET) of the driver I, feed back the offset to a switching power supply converter connected with the driver I, so as to control change of the drain voltage of the third-level MOSFET of the driver I.

3. The apparatus of claim 1, wherein, the driver Q feedback control unit comprises a second temperature sensor and a second direct compensation module; wherein,
the second temperature sensor is connected with the driver Q and is configured to detect the temperature change of the driver Q; and
the second direct compensation module is configured to compensate in light of a temperature compensation curve and according to the temperature change of the driver Q, and after obtaining an offset of a drain voltage of a third-level MOSFET of the driver Q, feed back the offset to a switching power supply converter connected with the driver Q, so as to control change of the drain voltage of the third-level MOSFET of the driver Q.

4. The apparatus of claim 2, wherein, the temperature compensation curve is obtained according to the driving amplitude of an output signal of the driver and the drain voltage of the MOSFET of the driver.

5. The apparatus of claim 1, wherein, the driver I feedback control unit comprises a first current monitoring module and a first indirect compensation module; wherein,
the first current monitoring module is connected with a drain voltage of a third-level MOSFET of the driver I and is configured to monitor current change of the drain voltage of the third-level MOSFET of the driver I; and
the first indirect compensation module is configured to control voltage change of a gate voltage of the third-level MOSFET according to the current change of the drain voltage of the third-level MOSFET of the driver I, and control the current change of the drain voltage of the third-level MOSFET by controlling the voltage change of the gate voltage of the third-level MOSFET.

6. The apparatus of claim 1, wherein, the driver Q feedback control unit comprises a second current monitoring module and a second indirect compensation module; wherein,
the second current monitoring module is connected with a drain voltage of a third-level MOSFET of the driver Q and is configured to monitor current change of the drain voltage of the third-level MOSFET of the driver Q; and
the second indirect compensation module is configured to control voltage change of a gate voltage of the third-level MOSFET according to the current change of the drain voltage of the third-level MOSFET of the driver Q, and control the current change of the drain voltage of the third-level MOSFET by controlling the voltage change of the gate voltage of the third-level MOSFET.

7. A method for controlling driving amplitude of a differential quadrature phase shift keying (DQPSK) transmitter, comprising:
modulating, by a DQPSK modulator, an optical signal emitted from a CW;
connecting a modulator feedback control unit with a first bias point, a second bias point and a third bias point, and controlling, by the modulator feedback control unit, the first bias point, the second bias point and the third bias point according to a part of the optical signal modulated by the DQPSK modulator;
controlling the driving amplitude of a driver I according to temperature change of the driver I;
controlling the driving amplitude of a driver Q according to temperature change of the driver Q.

8. The method of claim 7, wherein, controlling the driving amplitude of the driver I according to the temperature change of the driver I comprises:
detecting the temperature change of the driver I;
compensating in light of a temperature compensation curve and according to the temperature change of the driver I, and after obtaining an offset of a drain voltage of a third-level metal oxide semiconductor field effect transistor (MOSFET) of the driver I, feeding back the offset to a switching power supply converter connected with the driver I, so as to control change of the drain voltage of the third-level MOSFET of the driver I;
and/or,
controlling the driving amplitude of the driver Q according to the temperature change of the driver Q comprises:
detecting the temperature change of the driver Q;
compensating in light of a temperature compensation curve and according to the temperature change of the driver Q, and after obtaining an offset of a drain voltage of a third-level MOSFET of the driver Q, feeding back the offset to a switching power supply converter connected with the driver Q, so as to control change of the drain voltage of the third-level MOSFET of the driver Q.

9. The method of claim 8, wherein, the temperature compensation curve is obtained according to the driving amplitude of an output signal of the driver and the drain voltage of the MOSFET of the driver.

10. The method of claim 7, wherein, controlling the driving amplitude of the driver I according to the temperature change of the driver I comprises:
monitoring current change of a drain voltage of a third-level MOSFET of the driver I;
controlling voltage change of a gate voltage of the third-level MOSFET according to the current change of the drain voltage of the third-level MOSFET of the driver I, and controlling the current change of the drain voltage of the third-level MOSFET by controlling the voltage change of the gate voltage of the third-level MOSFET;
and/or,
controlling the driving amplitude of the driver Q according to the temperature change of the driver Q comprises:
monitoring current change of a drain voltage of a third-level MOSFET of the driver Q;
controlling voltage change of a gate voltage of the third-level MOSFET according to the current change of the drain voltage of the third-level MOSFET of the driver Q, and controlling the current change of the drain voltage of the third-level MOSFET by controlling the voltage change of the gate voltage of the third-level MOSFET.

11. The apparatus of claim 3, wherein, the temperature compensation curve is obtained according to the driving amplitude of an output signal of the driver and the drain voltage of the MOSFET of the driver.
